(19) United States
(12) Patent Application Publication
(10) Pub. No.: US 2025/0001969 A1
(43) Pub. Date: Jan. 2, 2025

(54) VEHICLE AIRBAG FABRIC

(71) Applicant: INV Performance Materials, LLC, Wilmington, DE (US)

(72) Inventors: John Alan Barnes, Dymock (GB); Jenna Ott, Kingston (CA); Anand Viswanath, Marietta, GA (US)

(21) Appl. No.: 18/709,821

(22) PCT Filed: Jan. 6, 2023
(86) PCT No.: PCT/IB2023/050112

§ 371 Date: May 14, 2024

Related U.S. Application Data
(60) Provisional application No. 63/298,148, filed on Jan. 10, 2022.

(51) Int. Cl. B60R 21/235; D03D 1/02; D03D 15/283; D03D 15/54

(52) U.S. Cl. CPC B60R 21/235; D03D 1/02; D03D 15/283; D03D 15/54; B60R 2021/23509; D10B 2505/124

(57) ABSTRACT

A vehicle airbag fabric comprises weft yarn and warp yarn. The weft yarn contains from ≥1 to ≤100 weight percent of recycled polymer material and has from ≥1 to ≤6 denier per filament (dpf), a tenacity of 65 to 80 cN/tex and a fluff content of ≤150 fluffs per million linear meters of yarn. The warp yarn contains equal or less recycled polymer material per unit weight than the weft yarn and has from ≥1 to ≤6 denier per filament (dpf) and a fluff content lower than that of the weft yarn.

### FIELD

The present disclosure relates to a fabric suitable for producing vehicle airbags and containing recycled polymer material.

### BACKGROUND

Inflatable airbags are a key component of vehicular safety systems. Airbags are typically made of woven synthetic fibers, such as nylon or polyester yarns. Like many other industries around the world, there is an increasing push for net carbon neutrality and other sustainability efforts in automotive manufacturing. One means to address this growing need is to employ recycled polymer in the airbag fiber manufacturing process. Historically, airbags have typically been made from virgin, or newly manufactured, polymer, as fiber manufactured using recycled polymer is typically not of suitable quality for the desired end use.

Polymer may be recycled through different means, including mechanical regrinding and remelting and/or chemical breakdown of polymer chains back to monomer constituents. Sources of recycle polymer feedstock and their respective quality can vary based on the step in the supply chain. Typical sources can include scrap from the polymer and/or fiber manufacturing process, scrap from the fabric weaving and/or cutting process, and fabric from decommissioned airbag modules, either pre- or post-deployment. In addition to finished product quality, other challenges introduced through the use of recycled polymer include traceability, consistency, and process efficiency. Traceability must be maintained throughout the process for quality control. Consistency in the recycle feedstock material is important to achieve the physical property aims and consistency required in the final fiber product.

Contaminants potentially introduced in the various steps of the process create challenges in the fiber spinning process, as they reduce the quality of the polymer and result in an increased content of broken filaments or “fluffs”. The additional heat history of polymer processed through mechanical recycling can also result in increased fluff content in fiber spinning due to the formation of thermal degradation products. Limitations around allowable fluff content in warp and weft yarns are in place to ensure the product is suitable for the required end use, meaning it is able to withstand the mechanical and tensile stresses of weaving and maintain an acceptable level of efficiency in downstream processing. Feedstock quality, the fiber manufacturing process, and the desired fiber properties must be optimized to achieve a final product of suitable quality for use in commercial airbag weaving.

EP2687628B1 discloses a fabric for use in forming a vehicle airbag, in which at least some of the yarns, particularly the weft yarns, are formed partially or entirely from recycled polymer material. However, EP2687628B1 is silent as to possible control parameters that could allow recycled polymer material to be successfully incorporated into an airbag fabric while minimizing loss of performance of the final airbag. The present disclosure seeks to address this problem.

### SUMMARY

In accordance with the present disclosure, it has now been found that that tenacity and denier per filament (DPF) can be used as control parameters for successfully incorporating recycled polymer material into at least the weft yarn of an airbag fabric. In some embodiments of the disclosed fabric, recycled polymer material can be incorporated into both the warp and weft yarns of an airbag fabric.

Thus, in one aspect, the present application provides a vehicle airbag fabric comprising:
(a) weft yarn containing from ≥1 to ≤100 weight percent of recycled polymer material, wherein:
   (i) the weft yarn has from ≥1 to ≤6 denier per filament (dpf), for example ≥2 to ≤4 denier per filament (dpf);
   (ii) the weft yarn has a tenacity of 65 to 80 cN/tex; and
   (iii) the weft yarn has a fluff content of ≤150 fluffs per million linear meters of yarn; and
(b) warp yarn containing equal or less recycled polymer per unit weight than the weft yarn, wherein:
   (i) the warp yarn has from ≥1 to ≤6 denier per filament (dpf), for example ≥2 to ≤4 denier per filament (dpf); and
   (ii) the warp yarn has a fluff content lower than that of the weft yarn.

In a further aspect, the present application provides a vehicle airbag fabric comprising:
(a) weft yarn containing from ≥1 to ≤100 weight percent of recycled polymer material wherein;
   (i) the weft yarn has a tenacity of 65 to 80 cN/tex; and
(b) warp yarn containing equal or less recycled polymer per unit weight than the weft yarn, wherein:
   (i) the tenacity of the warp yarn is within ±10% of the tenacity of the weft yarn; and
   (ii) the warp yarn has fewer fluffs per million linear meters than the weft yarn.

### DETAILED DISCLOSURE OF THE EMBODIMENTS

Disclosed is a vehicle airbag fabric comprising weft yarn and warp yarn, wherein at least part of the weft yarn and, in some cases, at least part of the warp yarn contains recycled polymer material. The remainder of both weft and warp yarns is composed of virgin polymer material. Generally, the virgin polymer of each of the weft and warp yarns is at least partially composed of nylon, such as nylon 6,6. Similarly, at least part of the recycled polymer material is composed of nylon, such as nylon 6,6.

In one embodiment, the vehicle airbag fabric disclosed herein comprises:
(a) weft yarn containing from ≥1 to ≤100 weight percent of recycled polymer material, wherein:
   (i) the weft yarn has from ≥1 to ≤6 denier per filament (dpf), for example ≥2 to ≤4 denier per filament (dpf);
   (ii) the weft yarn has a tenacity of 65 to 80 cN/tex; and
   (iii) the weft yarn has a fluff content of ≤150 fluffs per million linear meters of yarn; and
(b) warp yarn containing equal or less recycled polymer per unit weight than the weft yarn, wherein:
   (i) the warp yarn has from ≥1 to ≤6 denier per filament (dpf), for example ≥2 to ≤4 denier per filament (dpf); and
   (ii) the warp yarn has a fluff content lower than that of the weft yarn.

In a further embodiment, the vehicle airbag fabric disclosed herein comprises
(a) weft yarn containing from ≥1 to ≤100 weight percent of recycled polymer material; wherein
   (i) the weft yarn has a tenacity of 65 to 80 cN/tex; and
(b) warp yarn containing equal or less recycled polymer per unit weight than the weft yarn, wherein:
   (i) the tenacity of the warp yarn is within ±10% of the tenacity of the weft yarn; and
   (ii) the warp yarn has fewer fluffs per million linear meters than the weft yarn.

As used herein, the term “fluffs” means a discontinuous filament in the fiber bundle that is visible on the surface of a yarn or fabric. As disclosed herein, “fluffs” are measured by optical detection. Fluff concentration is expressed as a count of visually observable discontinuities (“fluffs”) per million linear meters of fiber. Fluffs can result in significantly reduced manufacturing process efficiencies and unsuitable final fabric quality. In particular, it has been found that above the 150 fluffs per million linear meters threshold, the quality of the weft yarn will negatively impact the runnability and efficiency of the weaving process and/or degrade fabric properties and/or quality through the creation of fabric defects. In general, fluff levels below 150 fluffs per million linear meters threshold are preferred for the weft yarn, such as ≤50 fluffs per million linear meters, even ≤5 fluffs per million linear meters. Fluff levels for the warp yarn are kept at or below those in the weft yarn and are preferably ≤5 fluffs per million linear meters.

### Recycled Polymer Material

Recycled polymer material may be sourced through the various steps of the supply chain, ranging from batch polymerization waste to recovered airbag modules at vehicle end of life. Additionally, there are non-airbag sources of recycled polymer material available that may be used. Usage of clean feedstock sources (such as fabric from undeployed versus scrap deployed airbags) will minimize the negative impact of contaminants. Recycled polymer material feedstock can be sourced via post-industrial and post-consumer routes and can include other alternatives to conventional nylon-6,6.

Different levels and qualities of recycled polymer material can be incorporated into as-produced nylon-6,6 (virgin polymer) for spinning into fiber. Impurities in the recycled polymer material can include moisture, spin finish, carbon, and additives deliberately introduced during initial manufacture/processing merely to name a few examples. Impurity levels can widely vary depending on the source of the recycled polymer material feedstock. Certain ranges of moisture, spin finish, and carbon as disclosed herein can be tolerated in the recycled polymer material and in the mixed virgin-recycled polymer material by adjusting the tenacity, DPF, and recycled polymer material percentage of the final product to provide a mixed virgin-recycled polymer material fiber having from ≥0 to ≤150 fluffs per million linear meters of yarn. Generally, it is desirable to minimize the content of reinforcing compounds in the recycled polymer material, for example it is desirable to minimize the content of glass fiber in the recycled polymer material.

Recycled polymer can be processed through different means, such as chemical or mechanical recycling. Chemical recycling, in which the input material is depolymerized back to its constituent monomers, may be used where appropriate depolymerization methods are available. Mechanical recycling, in which the scrap material is processed through regrinding and re-extrusion, is more commonly used. In this process, it is important to control the filtration rate of the extruded material in order to improve contaminant removal. Additionally, as with any fiber manufacturing process, it is important to control the impact of the re-extrusion process itself, including controlling extruder cleanliness to avoid additional introduction of contaminants, control the formation of thermal degradation species in the extrusion process (controlling process temperatures, maintaining adequate process shear rates and residence time, eliminating cold zones, etc.). Pellet size consistency and moisture content should also be controlled. In certain circumstances, additives may be used to optimize certain parameters of the recycled polymer material, such as RV or heat stabilizers.

### Fiber Manufacturing Process

In embodiments, introduction of the recycled polymer into the fiber manufacturing process is optimized to improve final product quality. Recycled polymer material should be adequately blended with the virgin polymer to ensure consistent polymer properties and quality. Additionally, recycled polymer material may be introduced into the polymer remelt process through a side stream when blended with virgin polymer to avoid an additional thermal exposure step. It is desirable to provide recycled polymer material having substantially the same particle shape and particle size distribution as the virgin polymer. Uniform shape and distribution has been found to promote uniform mixing and incorporation of the recycled polymer material into the final mixed virgin-recycled polymer composition.

After extrusion of the mixed virgin-recycled polymer composition, the resultant yarn is quenched (cooled) before being drawn. The quench process should be optimized to balance final fiber properties, such as variable denier, with fluff formation. Generally, a more moderate quench process (lower quench air flow, delayed quenching) has been found to result in lower fluff formation.

Manufacturing speed (the polymer throughput in the fiber manufacturing process) should also be optimized to improve finished product quality. Throughput may be reduced to achieve improved fluff levels.

Ideally the number of times that a polymer has been recycled should be known and controlled. More recycling iterations is desired from an overall sustainability perspective, as this is an enabler of supply chain circularity and reduces the amount of virgin material utilized. However, the number of times a polymer is recycled must be balanced by its increased thermal history.

Recycled polymer material content percentage can be modified to improve finished product quality. A lower percentage of recycled polymer material content can be used to improve fluff levels. Suitable ranges of recycled polymer material content include the following:
≥1 to ≤100 weight percent of weft yarn;
≥20 to ≤60 weight percent of weft yarn; and
≥30 to ≤50 weight percent of weft yarn.

Typically, the warp yarn contains equal or less recycled polymer per unit weight than the weft yarn.

Increased tenacity in the yarn is achieved through increased draw during the fiber spinning process, however, it comes with the tradeoff of increased fluff content. The aim is to optimize the balance between these two properties. The tradeoff between tenacity and increased fluff content is influenced by the percentage of recycle content in the fiber as well as the quality of the recycle feedstock.

Suitable ranges for tenacity in the weft yarn include the following:
≥65 to ≤80 cN/tex; and
≥70 to ≤80 cN/tex.

Generally, the tenacity of the warp yarn is held at within ±10% of the tenacity of the weft yarn.

Suitable ranges for denier per filament (dpf) for both the warp and weft yarns include the following:
≥1.0 dpf to ≤6.0 dpf;
≥1.5 dpf to ≤4.5 dpf; and
≥2.0 dpf to ≤4.0 dpf.
   with lower denier per filament (dpf) being preferable, both from a spinning perspective and from other industry requirements. For example, low denier per filament (dpf) products can be quenched more rapidly than their high dpf counterparts, resulting in lower spherulite growth and fewer fluffs formed during the subsequent spinning process.

The disclosed airbag fibers can include additives to protect the recycled polymer material polymer from thermal degradation and chain branching. Such additives can include phosphinate compounds and metal halides. Metal halides are suitable as thermal protection agents in virgin nylon polymer spinning. For the disclosed process, increased concentrations of metal halides (above the levels normally used in virgin nylon polymer spinning) are suitable to provide further protection against the additional heat exposure involved in mechanical recycling.

The disclosed airbag fabric may include recycled yarn that contains a chemical marker which identifies it as recycled material. Suitable chemical markers include trace colorants, pigments or fluorescents, metals, halides, molecular tags or other readily detectible materials.

Recycled polymer material feedstock quality is important to control, as introduction of contaminants or other impurities will negatively impact the efficiency of the spinning process and the quality of the spun recycled fiber. Examples of such contaminants can include spin finish content from the fiber spinning process, increased or variable moisture content from water jet weaving, and silicone coating from downstream processing steps, and polyacrylic acid size or oils and fats from warp pretreatment to act as weaving assists. Properties of the recycled polymer material can be controlled to optimize fiber spinning performance. Examples of suitable variables and values include moisture content (such as <1500 ppm for polyamides), metal contamination (such as <50 ppm), finish oil content (such as <2% by weight), merely to name a few. One way to adjust recycled polymer material composition is to preferentially source materials from known “clean” sources, such as fiber manufacturing and water jet weaving scrap. Another way is through additional treatment of the feedstock materials, such as separation of silicone coating from the substrate material prior to recycle processing, use of a washing and/or drying process to remove spin finish and/or residual size or other weaving aids and to control moisture content prior to processing, use of a vented extruder during the remelting step to remove unwanted gaseous byproducts, or some combination of these.

Another potential control parameter is the relative viscosity (RV) variation of the recycled polymer material. Size control during the re-pelletization process of the recycled polymer material is important to this step; additionally, it improves blending consistency if mixing with virgin polymer pellets. Blending prior to pellet consumption, whether with virgin material or within a lot of recycled polymer material pellets, may also assist in reducing polymer property variation. Batch mixers or flow channel blenders can be used achieve this blending.

Due to the source of the recycled polymer material feedstock, the re-pelletized polymer can have higher RV than the comparative virgin material. To control the resulting RV of the blended (virgin and recycled polymer material) polymer and minimize additional thermal degradation caused by further increasing the heat history of the recycled material, the recycled polymer material pellets can be co-fed into the virgin polymer remelt system prior to extrusion. This will also help control the recycled polymer coloration differential compared to virgin polymer. The recycled polymer material pellets can optionally be conditioned in a separate system to the virgin polymer pellets prior to co-feeding if some RV increase prior to extrusion is desired.

Feedstock processed through mechanical recycling will have higher levels of degradation due to the polymer's additional heat history from the re-pelletization and polymer extrusion process prior to spinning. One way to minimize thermal degradation is to directly feed shredded recycled polymer material feedstock into the extruder, eliminating the re-pelletizing step. Additionally, various additives can be used to protect the recycled polymer material from thermal degradation and chain branching. Such additives can include phosphinate compounds and metal halides. While metal halides are already commonly used as a thermal protection agent in virgin nylon polymer spinning, increased concentrations can be used to provide further protection against the additional heat exposure involved in mechanical recycling. As mentioned above, the re-extrusion process itself may be controlled to limit introduction of contaminants and formation of other degradation species such as carbon formed through oxidative degradation. Polymer quality, influenced by both the quality of the feedstock and the impact of the recycling process itself, is important in the downstream fiber spinning process. Polymer quality is suitably controlled, for example, to maintain acceptable an acceptable pack pressure rate of rise (<0.25 psi/kg). Increased pack filtration can be used to improve fiber spinning performance (and reduce fluff formation). These benefits are balanced against increasing the rate of pressure rise across filtration packs.

The fiber is then formed by extruding filaments of molten polymer, containing some percentage of recycled polymer material content, through spinnerets at high temperatures and pressures. The filaments are then quenched in air, coated in lubricant, drawn between pairs of heated godets, lightly textured to provide enough entanglement to make a cohesive fiber bundle, and wound onto tube cores to form a bobbin.

Woven fabric is then formed from warp and weft yarns using weaving techniques known in the art. Due to the mechanical and tensile stresses of weaving, fiber fluff content in both warp and weft bobbins must be controlled to maintain suitable fabric quality and loom efficiency. Use of recycled polymer material has the potential to increase the level of fluff produced during fiber spinning if the recycled polymer material is of lower quality than the virgin polymer or contains contaminants. Several solutions are used in the present process to control fluff production such that the spinning process is able to operate at acceptable efficiencies. Such solutions can include reducing the throughput of the spinning process, reducing the tenacity of the final fiber product, manipulating the level of recycled polymer material content used in the spinning process, limiting the number of times material may be recycled, and/or using differential levels of recycled polymer material in the warp and weft bobbins. Due to the stresses of warping/beaming, fluff limitations are more restrictive in the warp direction. To meet these limitations at a particular fiber tenacity while maximizing overall recycled polymer material content in the fabric, more recycled polymer material content can be used in the weft fiber spinning process, as higher fluff content is acceptable.

Maintaining a minimum elongation in the spun fiber is important to hold efficiency during the weaving process and to retain the performance of the final fabric. As polymer quality decreases, due to factors such as thermal degradation and other contaminants, the elongation of the spun fiber can also begin to decrease. One solution to this problem is to reduce the tenacity of the spun fiber, such as to 65 to 80 cN/tex, thereby preserving elongation.

The number of iterative recycling steps the polymer is subjected to should also be regulated to avoid the loss of physical properties and control the effect of increased thermal and/or oxidative degradation and contamination. To control the effects of iterative recycling, polymer recycled more than once may be used in combination with polymer undergoing its first recycling treatment. The balance of these two types of recycled polymer may be manipulated in response to factors such as spinning performance and/or desired fiber tenacity.

The invention will now be more particularly described with reference to the following non-limiting Examples and the results are shown in Table 1 below.

In the Examples and the remainder of the present specification, the following tests are used to generate the results given.

Fluff levels are measured using online optical detection. Each threadline passes through an infrared sensor; disruption in the infrared beam indicate presence of a fluff. The number of fluffs detected is then normalized to one million meters of linear fiber length.

Fiber breaking strength and elongation at break are measured per ASTM D885.

Denier is measured per ASTM D1907.

Tenacity is calculated using fiber breaking strength and denier.

Construction (also known as fabric count) is measured per ISO 7211-2 (1984).

Fabric tensile strength (N) (also known as maximum force) and elongation at maximum force (%) is tested according to standard ISO 13934-1 (2013) with the following amendments:
The initial gauge (clamp) length set on the Instron tensile tester is 200 mm.
The Instron crosshead speed is set at 200 mm/min.
Fabric specimens are cut initially to size 350×60 mm but are then frayed down by unravelling the long edge threadlines to a testing width of 50 mm.
Tensile testing is done on 5 warp direction & 5 weft direction specimens cut from each test fabric in a diagonal cross pattern & avoiding any areas within 200 mm of the fabric selvedges.
The reported result for maximum force (also known as breaking force or breaking load) is the mean average of the maximum force results of the five warp direction specimens & (separately) the five weft direction specimens which were tested in Newtons (N).
The reported result for elongation at maximum force (also known as percentage elongation or percentage extension) is the mean average of the elongation at maximum force results of the five warp direction specimens & (separately) the five weft direction specimens which were tested (%). Tear strength is measured per EASC 9904 0180 3.17, which specifies test standard ISO 13937-2 with the following amendments:
Cut specimens IAW with section 4.07 with slits extending from the midpoint of the end edge to the center as shown.

Tear strength (also known as tear force) is measured per ISO 13937-2 (2000) with the following amendments:
The fabric specimen size is 150 mm×200 mm with a 100 mm slit extending from the midpoint of the narrow end to the center.
Tear testing is done on 5 warp direction & 5 weft direction specimens cut from each test fabric in a diagonal cross pattern & avoiding any areas within 200 mm of the fabric selvedges.
Warp direction tear results are obtained from tested specimens where the tear is made across the warp (i.e. warp threadlines are torn) whilst weft direction results are obtained from tested specimens where the tear is made across the weft (i.e. weft threadlines are torn).
Each leg of the specimens is folded in half and secured in the Instron clamp grips according to ISO 13937-2 annex D/D.2
Evaluation of test results is according to ISO 13937-2 section 10.2 “Calculation using electronic devices”.
The reported result for warp tear force is the mean average of the tear force results of the five warp direction specimens in Newtons (N), whilst for weft tear force it is the mean average of the tear force results of the five weft direction specimens.

Stiffness is measured per ASTM D4032-08 (2016) with the following amendments:
The plunger stroke speed is 2000 mm/min
Stiffness testing is done on 5 warp direction & 5 weft direction specimens cut from each test fabric in a diagonal cross pattern & avoiding any areas within 200 mm of the fabric selvedges.
Each 200×100 mm specimen is single folded across the narrow dimension before being placed on the instrument testing platform for testing
The reported result (in Newtons) for warp stiffness is the mean average of the stiffness results of the five warp direction specimens whilst the result for weft stiffness is the mean average of the five weft direction specimens.
The warp direction stiffness results are obtained from tested specimens where the longest dimension (200 mm) is parallel to the fabric warp direction, whilst weft direction results are obtained from tested specimens where the longest dimension (200 mm) is parallel to the fabric weft direction.

Edgecomb resistance (also known as edge pullout testing) is measured in Newtons (N) and is tested according to standard ASTM D6479-15 (2020) but with the following amendments:
The edge distance is 5 mm—this is the distance between the end of the test specimen (which during testing is positioned on a narrow ledge machined in the test specimen holder) & the line of pins which perform the “pullout”, i.e. this is the length of the section of threadlines pulled out during the test.
Edgecomb resistance testing is done on 5 warp direction & 5 weft direction specimens cut from each test fabric in a diagonal cross pattern & avoiding any areas within 200 mm of the fabric selvedges.
The warp direction edgecomb resistance results are obtained from testing specimens with the long dimension parallel to the warp yarns, whilst weft direction results are obtained from testing specimens where the long dimension is parallel to the weft yarns.
The reported result for warp edgecomb resistance is the mean average of the edgecomb resistance results of the five warp direction specimens in Newtons (N), whilst for weft edgecomb resistance it is the mean average of the results of the five weft direction specimens.

Static air permeability (I/dm²/min) is tested according to test standard ISO 9237 (1995) but with the following amendments:
The test area is 100 cm²
The test pressure (partial vacuum) is 500 Pa.
Each individual test value is corrected for edge leakage.
Static Air Permeability testing is done at six sites on a test fabric in a sampling pattern across and along the fabric in order to test 6 separate areas of warp and weft threadlines within the fabric.
The reported Static Air Permeability result is the mean value of the six corrected measurements in units of I/dm²/min.

Dynamic air permeability is tested according to test standard ASTM D6476-12 (2021) with the following amendments:
The limits of the measured pressure range (as set on the test instrument) are 30-70 kPa
The start pressure (as set on the test instrument) is adjusted to achieve a peak pressure of 100+/−5 kPa.
The test head volume is 400 cm³ unless the specified start pressure cannot be achieved with this head, in which case one of the other interchangeable test heads (volumes 100, 200, 800 & 1600 cm³) should be used as is found to be appropriate for the fabric under test.
Dynamic Air Permeability testing is done at six sites on a test fabric in a sampling pattern across and along the fabric in order to test 6 separate areas of warp and weft threadlines within the fabric.
The reported Dynamic Air Permeability result is the mean value of the six DAP measurements in units of mm/second.

### Comparative Example No. 1

An airbag is made of conventional, 100% virgin nylon 6,6 polymer in both the warp and weft fibers. Fiber properties are suitable for use in airbag weaving. Results are reported below in Column C1 in Table 1.

### Comparative Example No. 2

An airbag is made of 100% post-industrial mechanically recycled nylon 6,6 polymer material in both the warp and weft fibers. Tenacity is significantly reduced to maintain acceptable elongation and fluff levels, however, the final fabric properties (tensile, tear) are outside the desired range for airbag applications. Results are reported below in Column C2 in Table 1.

### Comparative Example No. 3

An airbag is made of 50% post-industrial mechanically recycled nylon 6,6 polymer material in both the warp and weft fibers without process optimization to ensure end-use suitability. Tenacity is maintained at standard virgin airbag levels and fiber dpf is not optimized. As a result, fiber elongation and fluff levels are not suitable for use in airbag fabric weaving. Results are reported below in Column C3 in Table 1.

### Inventive Example No. 1

An airbag is made of 30% post-industrial mechanically recycled nylon 6,6 polymer material in both the warp and weft fibers, the remainder of both warp and weft fibers being virgin nylon 6,6 polymer. Tenacity is dropped to maintain acceptable fiber elongation and fluff levels. Resulting fabric properties are suitable for airbag end use. Results are reported below in Column 11 in Table 1.

### Inventive Example No. 2

An airbag is made of warp fibers containing 20% post-industrial mechanically recycled nylon 6,6 polymer material and weft fibers containing 50% post-industrial mechanically recycled nylon 6,6 polymer material. The remainder of both the warp and weft fibers is virgin nylon 6,6 polymer. Fiber tenacity is adjusted to balance final fabric properties with acceptable elongation and fluff content. Results are reported below in Column 12 in Table 1.

TABLE 1

| | | | | Examples | | | | |
|---|---|---|---|---|---|---|---|---|
| | Property | Units | Direction | C1 | C2 | C3 | I1 | I2 |
| Fiber | Decitex | g/10,000 | — | 480 | 480 | 471 | 480 | 480 |
| | | m | | | | | | |
| | DPF | Denier | — | 3.5 | 3.5 | 6.9 | 3.5 | 3.5 |
| | | per | | | | | | |
| | | Filament | | | | | | |
| | Tenacity | cN/tex | Warp | 80 | 60 | 85 | 70 | 75 |
| | | | Weft | 80 | 60 | 85 | 70 | 70 |
| | Elongation | % | Warp | 22.0 | 22.0 | 18.5 | 22.5 | 21.5 |
| | at Break | | Weft | 22.0 | 22.0 | 18.5 | 22.5 | 22.0 |
| | Recycled | % by | Warp | 0 | 100 | 50 | 30 | 20 |
| | polymer | weight | Weft | 0 | 100 | 50 | 30 | 50 |
| | material | | | | | | | |
| | Content | | | | | | | |
| | Fiber Quality | Fluff per | Warp | <5 | <5 | >5,000 | <5 | <5 |
| | | million | Weft | <150 | <150 | >5,000 | <150 | <150 |
| | | meters | | | | | | |
| Fabric | Construction | ends/cm | Warp | 19.5 | 19.5 | 19.5 | 19.5 | 19.5 |
| | | | Weft | 19.5 | 19.5 | 19.5 | 19.5 | 19.5 |
| | Tensile | N | Warp | 3300 | 2500 | 3500 | 2900 | 3100 |
| | Breaking | | Weft | 3500 | 2600 | 3800 | 3000 | 3000 |
| | Strength | | | | | | | |
| | Tensile | % | Warp | 35 | 35 | 29.0 | 36 | 34 |
| | Elongation | | Weft | 30 | 35 | 25.0 | 31 | 30 |
| | Tear | N | Warp | 180 | 135 | 210 | 160 | 170 |
| | Strength | | Weft | 180 | 135 | 205 | 160 | 160 |
| | Stiffness | N | Warp | 15.0 | 15.0 | 16.0 | 15.0 | 15.0 |
| | | | Weft | 19.0 | 19.0 | 20.0 | 19.0 | 19.0 |
| | Edgecomb | N | Warp | 550 | 550 | 520 | 550 | 550 |
| | Resistance | | Weft | 650 | 650 | 615 | 650 | 650 |
| | Static Air | l/dm²/min | — | 2.35 | 2.35 | 9.65 | 2.35 | 2.35 |
| | Permeability | | | | | | | |
| | Dynamic Air | mm/s | — | 400 | 400 | 1000 | 400 | 400 |
| | Permeability | | | | | | | |
| | aDAP | — | — | 1.20 | 1.20 | 1.00 | 1.20 | 1.20 |
| | Exponent | | | | | | | |

1-12. (canceled)

13. A vehicle airbag fabric comprising:
(a) weft yarn containing from ≥1 to ≤100 weight percent of recycled polymer material, wherein:
(i) the weft yarn has from ≥1 to ≤6 denier per filament (dpf), for example ≥2 to ≤4 denier per filament (dpf);
(ii) the weft yarn has a tenacity of 65 to 80 cN/tex; and
(ii) the weft yarn has a fluff content of ≤150 fluffs per million linear meters of yarn; and
(b) warp yarn containing equal or less recycled polymer per unit weight than the weft yarn, wherein:
(i) the warp yarn has from ≥1 to ≤6 denier per filament (dpf), for example ≥2 to ≤4 denier per filament (dpf); and
(ii) the warp yarn has a fluff content lower than that of the weft yarn.

14. The fabric of claim 13, wherein the warp yarn and weft yarn differ in tenacity by no more than 10%.

15. The fabric of claim 13, wherein the weft yarn has from ≥2 to ≤4 denier per filament (dpf).

16. The fabric of claim 13, wherein the warp yarn has from ≥2 to ≤4 denier per filament (dpf).

17. The fabric of claim 13, wherein the weft yarn contains ≥20 to ≤60 weight percent of recycled polymer material.

18. The fabric of claim 13, wherein the weft yarn contains ≥30 to ≤50 weight percent of recycled polymer material.

19. The fabric of claim 13, wherein the weft yarn has a fluff content of ≤50 fluffs per million linear meters of yarn

20. The fabric of claim 13, wherein the recycled polymer material contains a chemical marker which identifies it as recycled material, wherein the chemical marker is at least one selected from the group consisting of a colorant, a fluorescent, a metal and a halide.

21. The fabric of claim 13, wherein the warp and weft yarns are at least partially composed of nylon.

22. The fabric of claim 13, wherein the recycled polymer material is at least partially composed of nylon.

23. A vehicle airbag fabric comprising:
(a) weft yarn containing from ≥1 to ≤100 weight percent of recycled polymer material;
wherein
(i) the weft yarn has a tenacity of 65 to 80 cN/tex; and
(b) warp yarn containing equal or less recycled polymer per unit weight than the weft yarn, wherein:
(i) the tenacity of the warp yarn is within ±10% of the tenacity of the weft yarn; and
(ii) the warp yarn has fewer fluffs per million linear meters than the weft yarn.

24. The fabric of claim 23, wherein the weft yarn has from ≥1 to ≤6 denier per filament (dpf).

25. The fabric of claim 23, wherein the warp yarn has from ≥1 to ≤6 denier per filament (dpf).

26. The fabric of claim 23, wherein the weft yarn contains ≥20 to ≤60 weight percent of recycled polymer material.

27. The fabric of claim 23, wherein the weft yarn contains ≥30 to ≤50 weight percent of recycled polymer material.

28. The fabric of claim 23, wherein the weft yarn has a fluff content of ≤50 fluffs per million linear meters of yarn

29. The fabric of claim 23, wherein the recycled polymer material contains a chemical marker which identifies it as recycled material.

30. The fabric of claim 29, wherein the chemical marker is at least one selected from the group consisting of a colorant, a fluorescent, a metal and a halide.

31. The fabric of claim 23, wherein the warp and weft yarns are at least partially composed of nylon.

32. The fabric of claim 23, wherein the recycled polymer material is at least partially composed of nylon.
